(19) United States
(12) Patent Application Publication
(10) Pub. No.: US 2008/0297364 A1
(43) Pub. Date: Dec. 4, 2008

(54) Method and apparatus to ensure activation of a power distribution alarm monitoring circuit

(75) Inventors: Edward E. Soderland, Oak Hill, VA (US); Michael S. Jaeger, Oak Hill, VA (US); Lucian K. Falconer, III, Leesburg, VA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Reston, Inc., Ashburn, VA (US)

(21) Appl. No.: 11/809,788

(22) Filed: Jun. 1, 2007

(51) Int. Cl. G08B 21/00

(52) U.S. Cl. 340/654

(57) ABSTRACT

Redundant load sharing power supplies may use lower amperage pilot fuses to monitor the condition of higher amperage main line fuses carrying load current. An alarm monitoring circuit is activated when the pilot fuse has blown. The load sharing characteristics of these supplies may proportion current such that the pilot fuse may not be blown when the main line fuse is missing or blown. An embodiment of the present invention provides a system for ensuring activation of a power distribution alarm monitoring circuit in a load sharing power application using multiple loads to draw current from the power inputs. A control circuit enables current to flow in a controlled manner to blow the pilot fuse to ensure activation of a power distribution alarm monitoring circuit. Ensuring activation of the alarm monitoring circuit allows accurate identification of a faulty supply and satisfies a required operations condition of many telecommunications systems providers.

### BACKGROUND OF THE INVENTION

To improve reliability and reduce system downtime, telecommunications systems, such as equipment in central offices, often employ redundant load sharing power supplies. The redundant nature of these power supply systems allow the telecommunications systems to continue to operate in the event that one power supply becomes damaged and can no longer provide power to the system. These power supplies typically employ fuses or circuit breakers to protect the circuits to which they are connected from over-currents and other abnormal operating conditions. Once the power supply becomes inoperative, the system operator is typically notified of the situation, so that a service technician may be dispatched in order to repair the faulty power supply.

To facilitate notifying the system operator, power distribution systems commonly employ an alarm monitor circuit. This circuit is used to monitor the state of a smaller amperage fuse, such as a pilot fuse, that is connected in parallel with a larger amperage main line fuse. Thus, when the higher amperage load bearing fuse is blown or missing, the current is forced to use a “shunt path” via the pilot fuse, which is blown due to its inability to carry the load current. Blowing the pilot fuse, in turn, activates the central office power alarm monitoring circuit associated with a particular power distribution system.

To reduce the cost and space requirements of two independent redundant power supplies, a load sharing architecture may be employed. To ensure the pilot fuse is blown when the main fuse is blown or missing, in a load sharing system, the voltage on each supply must be matched. However, the nature of load sharing power supply systems may result in the system proportioning the current in a manner that does not blow the pilot fuse when the main fuse is missing or blown. As a result, the alarm monitor circuit may not be able to detect the faulty power supply.

### SUMMARY OF THE INVENTION

A system for ensuring activation of a power distribution alarm monitoring circuit in a load sharing power application according to an example embodiment of the invention may include multiple loads configured to draw current from the power inputs. The example system may include a control circuit configured to enable, in a controlled manner, current flow from the power inputs to the loads at levels to ensure activation of a power distribution alarm monitoring circuit monitoring the power inputs.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of a power distribution system employing an example embodiment of the invention;

FIG. 2A is a block diagram illustrating in further detail an example embodiment of the invention;

FIGS. 2B-2E are block diagrams illustrating a time sequence of events depicting a number of states occurring in an example embodiment of the invention;

FIG. 3 is a schematic diagram of a pilot fuse control circuit of FIG. 2A in accordance with an example embodiment of the invention;

FIG. 4 is a schematic diagram of a power “OR'ing” and conversion circuit 245 of FIG. 2 in accordance with an example embodiment of the invention;

FIG. 5A is an oscilloscope screen capture depicting an output of an astable multivibrator relative to a monostable multivibrator shown in FIG. 3;

FIG. 5B is an oscilloscope screen capture depicting the monostable multivibrator output relative to the astable multivibrator output depicted in FIG. 3;

FIG. 5C is an oscilloscope screen shot depicting the astable multivibrator period relative to the monostable multivibrator output depicted in FIG. 3;

FIG. 6 is a flow diagram illustrating an example embodiment of the invention; and

FIG. 7 is a flow diagram illustrating an example embodiment of the invention.

### DETAILED DESCRIPTION OF THE INVENTION

A description of example embodiments of the invention follows.

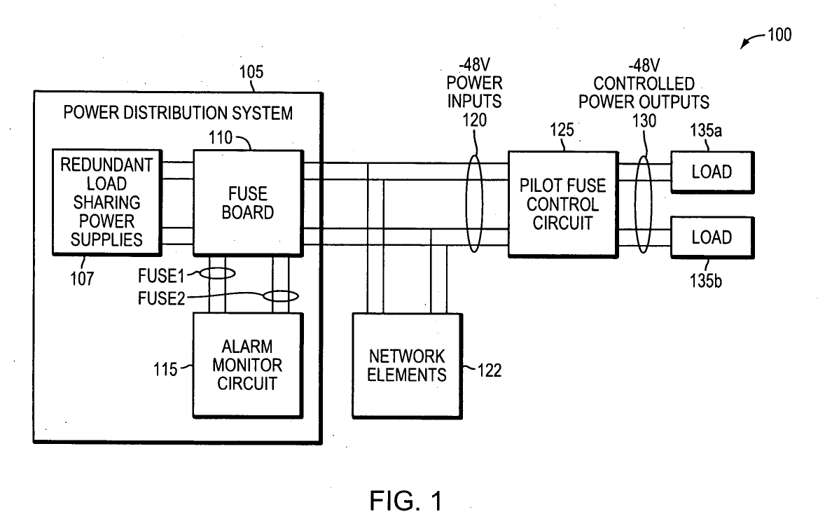

FIG. 1 is a simplified block diagram of a telecommunications systems' network power architecture 100 in accordance with an example embodiment of the invention. The network power architecture 100 includes a power distribution system 105, a pilot fuse control circuit 125, and multiple loads 135a-b. The power distribution system 105 may include redundant load sharing power supplies 107, battery distribution fuse board 110, and alarm monitor circuit 115. Power outputs 120 are connected from the power distribution system 105 to the pilot fuse control circuit 125. Control power outputs 130 are connected from the pilot fuse control circuit 125 to the multiple loads 135a-b. The network power architecture 100 may be positioned at any suitable location within or external from the telecommunications power network, for example, at a central office in order to facilitate delivery and transmission of power to the telecommunications system.

The battery distribution fuse board 110 may contain fuses and/or circuit breakers to protect both the power distribution system 105 and network elements 122 it provides power to in the event of an over-current or other abnormal operating condition. The alarm monitor circuit 115 provides the capability to monitor a fuse and generate a notification indicator to notify, for example, a system operator in the event a fuse has blown indicating a power supply has failed. The alarm monitor circuit 115 may by connected to at least one fuse of the fuse board 110.

In an example embodiment of the invention, a system to ensure activation of a power distribution alarm monitoring circuit in a load sharing power application may include multiple loads configured to draw current from power inputs in a load sharing manner. A control circuit may be configured to enable, in a controlled manner, current flow from the power inputs to the loads at levels to ensure activation of the power distribution alarm monitoring circuit monitoring the power inputs.

The control circuit, in combination with the load, may cause an increase in current flow to the load for a length of time above a level (e.g., between 0.25 and 10 amperes) to ensure activation of the power distribution alarm. The control circuit may also enable the current to flow in a timed manner, such as, periodic, aperiodic, or selectable. The control circuit may further contain at least one multivibrator, for example, an astable multivibrator and a monostable multivibrator. The control circuit may further still cause the current flow to have at least two states with one state higher current flow than the other state. The control circuit may also cause the current flow to have an ‘on’ time and an ‘off’ time wherein the current flow ‘on’ time is substantially less than the current flow ‘off’ time.

The system may further include switching devices connected to respective loads, wherein the control circuit is configured to provide a control signal to the switching devices to enable the current to flow from the power inputs to the loads via the switching devices. The system may also include a circuit to derive an operational voltage to power the control circuit from at least one of the power inputs, and continue to operate in an event of a loss of power from a power input, and may be floating relative to ground. The loads may be active, passive, or a short to a reference voltage potential, and may be equal number as the power inputs, and may be configured in banks of loads connected to respective power inputs. The system may be for use in a telecommunications application.

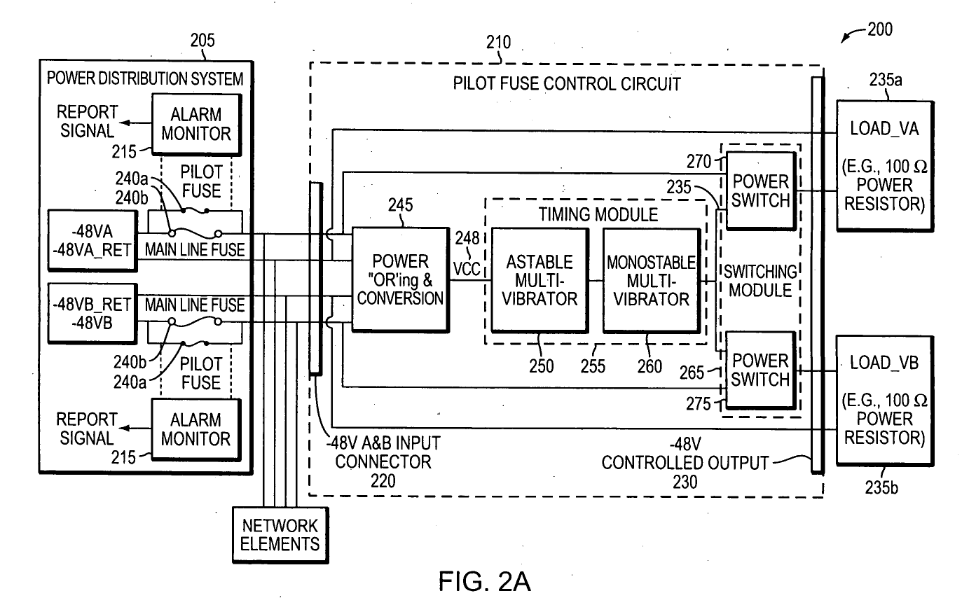

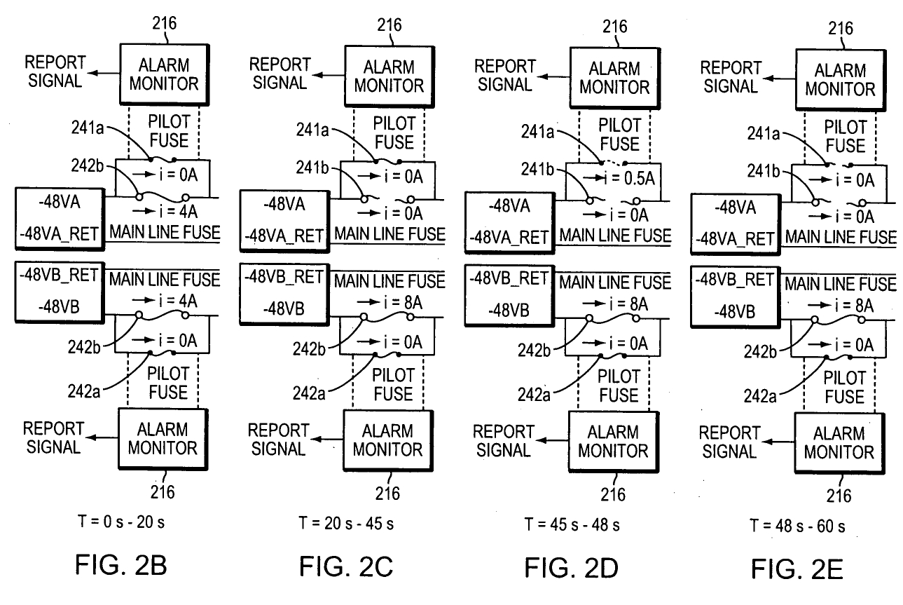

FIG. 2A is a more detailed diagram of a power system 200 employing a pilot fuse control circuit 210 according to an example embodiment of the invention. The pilot fuse control circuit 210 may include an input power connector 220, and a power “OR'ing” and conversion circuit 245. The timing module 255 may include, for example, an astable multivibrator 250 and a monostable multivibrator 260. A switching module 265 may include, for example, power switches 270 and 275 used to switch power to a plurality of loads 235a-b.

In one embodiment of the invention, the power distribution system 205 may contain redundant load sharing power supplies, shown as −48 VA and −48 VB and their corresponding return lines −48 VA_RET and −48 VB_RET, respectively. The power supplies may be configured in a parallel configuration such that they share the load. Load sharing distributes current equally among the paralleled power supplies. This configuration allows for redundant backup of the power supplies and, in addition, may allow “hot-swap” capability where loads can be replaced without requiring the system to be powered down or disconnected.

The supplies are typically protected using main line fuses 240b to protect against over-current or abnormal operating conditions. Pilot fuses 240a may be used to monitor the condition of the main line fuses 240b. A pilot fuse 240a is typically a small amperage fuse wired in parallel with a larger load bearing fuse 240b and serves as an alarming mechanism. When the higher amperage main line fuse 240b is blown or missing, the current is forced through the pilot fuse 240a via a “shunt path”, which forces the pilot fuse 240a to blow due to its inability to carry the load because of its much lower amperage rating.

An alarm monitor circuit 215 may be used to detect when a pilot fuse is blown and may activate, for example, a central office power alarm associated with the particular power supply. If the voltages on each feed line (i.e., −48 VA and −48 VB) are matched, the pilot fuses 240a will be blown if the main line fuses 240a are missing or blown. However, the load sharing characteristics of the redundant supplies, as described above, may result in the current being proportioned in a manner that may not blow the pilot fuse 240a when the main line fuse 240b is missing or blown.

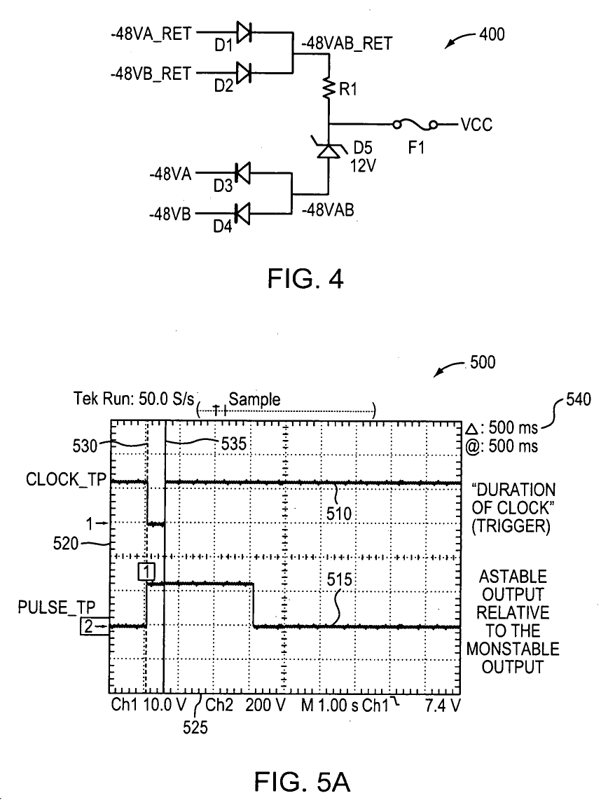

The power supply outputs of the power distribution system 205 are connected to the pilot fuse control circuit 210 via a −48 VA & B input power connector 220. The −48V inputs are then connected to the power OR'ing and conversion circuit 245 which is described below in further detail in reference to FIG. 4. The −48V A & B inputs are also connected to the switching module 265, and the −48V A & B RET lines are connected to the loads 235a-b.

The power OR'ing and conversion circuit 245 may generate a VCC voltage 248. The generated VCC voltage 248 may be, for example, 12 volts DC with reference to the −48 VA & B inputs and may be used to power the timing module 255 circuits, such as the astable multivibrator 250 and monostable multivibrator 260.

The timing module 255 may be used to generate a timing signal 225 that is connected to the switching module 265. In one example embodiment, an astable multivibrator 250 may be used to generate a period clock signal that determines how often (e.g., a period) the switching module 265 is turned on and off. A monostable multivibrator 260 may be used to determine how long the switching module 265 is switched ‘on.’ For example, a timing signal may be generated such that the switching 4module is turned on every 45 seconds for 3 seconds. By drawing current at a low duty cycle, power is conserved.

The switching module 265 may be implemented, for example, using power switches 270 and 275. The output of the power switches 270 and 275 and the −48 VA_RET and −48 VB_RET lines are connected to the loads 235a-b via −48V control output connector 230. Multiple loads 235a-b may be provided such that a load is present for each redundant power supply. In the example embodiment, the power switches may be switched ‘on’ such that current is allowed to be drawn from the −48 VA and −48 VB supplies by loads 235a and 235b. The loads may be configured such that the amount of current drawn is sufficient to ensure that the respective pilot fuses 240a are blown in the event the main line fuse 240b is blown or missing.

FIGS. 2B-2E depict a time sequence of events illustrating the state of pilot fuses 241a-242a, and main line fuses 241b-242b according to an example embodiment of the invention. In this example, power supplies −48 VA and −48 VB provide current to loads, such as network elements 122 shown in FIG. 1. At approximately 20 seconds, power supply −48 VA experiences an over-current situation causing its main line fuse to be blown. Due to the power supplies load sharing nature, the other supply −48 VB provides all the current to the network element(s), and, consequently, the pilot fuse 241a associated with power supply −48 VA remains intact. Between 45-48 seconds, each load associated with each power supply draws 0.5 amperes, causing the pilot fuse associated with the over-current power supply −48 VA to be blown.

FIG. 2B illustrates an example embodiment where both power supplies -48A and −48 VB are operating in a normal, non-faulty manner, depicted as occurring between 0-20 seconds. For example, the power supplies −48 VA and −48 VB may provide 4 amperes, or a total of 8 amperes, to the network element(s). The fuses may be configured such that the current flows through the main line fuses 241b and 242b when they remain intact and flow through the pilot fuses 241a and 242a when the main line fuses 241b and 242b are missing or blown. Because the main line fuses 241b and 242b remain intact, most, if not all, the current flows through main line fuses 241 b and 242b, and little (i.e., less than its rating) or no current flows through the ‘shunt path’ and pilot fuses 241a and 242a.

FIG. 2C illustrates an event where, for example, an over-current condition occurs, resulting in the main line fuse 241b of the −48 VA power supply being blown, and is depicted as occurring between 20-45 seconds. However, due to the load sharing characteristics of redundant power supplies −48 VA and −48 VB, the 8 amperes of current is proportioned such that the −48 VB supply provides most, if not all, the current to the load. As a result, the pilot fuse 241 a for power supply −48 VA the remains intact, preventing an alarm monitor 215 from detecting the faulty −48 VA power supply and, thus, will not activate a power distribution alarm monitoring circuit (not shown).

FIG. 2D illustrates an example where a control circuit may enable, in a controlled manner, current to flow from the power inputs to multiple loads at levels to ensure activation of the power distribution alarm monitoring circuit. At approximately 45 seconds, each load, such as loads LOAD_VA and LOAD_VB shown on FIG. 2A, independently draw approximately 0.5 amperes from each power supply −48 VA and −48 VB. Since the main line fuse 241b of power supply −48 VA is blown, the 0.5 amperes flows through the ‘shunt path’ and pilot fuse 241a, eventually blowing the pilot fuse 241a. The load associated with power supply −48 VB also draws 0.5 amperes. However, because its main line fuse is still intact, the additional current flows through the main line fuse 242b (assuming the total current does not exceed the main line fuse rating), and the pilot fuse 242a remains intact.

FIG. 2E illustrates the resulting state of the fuses, depicted as the time period after 48 seconds. The main line fuse 241b and the pilot fuse 241a associated with the faulty power supply −48 VA are blown. Subsequently, the alarm monitor 216 detects the faulty power supply −48 VA, as indicated by the blown pilot fuse 241a, ensuring activation of a power distribution alarm monitoring circuit in a load sharing power application. Power supply −48 VB continues to operate in a non-faulty manner, with both fuses 242a and 242b intact, to provide current the network elements.

Thus, the controlled manner in which current flows from the power inputs to the loads refers to the magnitude of the current, and may also include the timing parameters during which the current flow is enabled and disabled. For example, the loads may be implemented using power resistors such that the current drawn by the loads exhibit a linear transfer function based on Ohm's law. Accordingly, the current drawn by the loads is a function of a voltage across the power resistors divided by the resistance. In an alternative embodiment, the load may also be implemented using electronic loads, such as, for example, a constant current, constant voltage, or constant resistance that may exhibit a non-linear transfer function. The electronic loads may enable current flow via power switches, such as MOSFET devices, mechanical relays, and the like. Alternatively, the electronic loads may be connected directly to the power inputs and enabled and disabled via, for example, digital control logic.

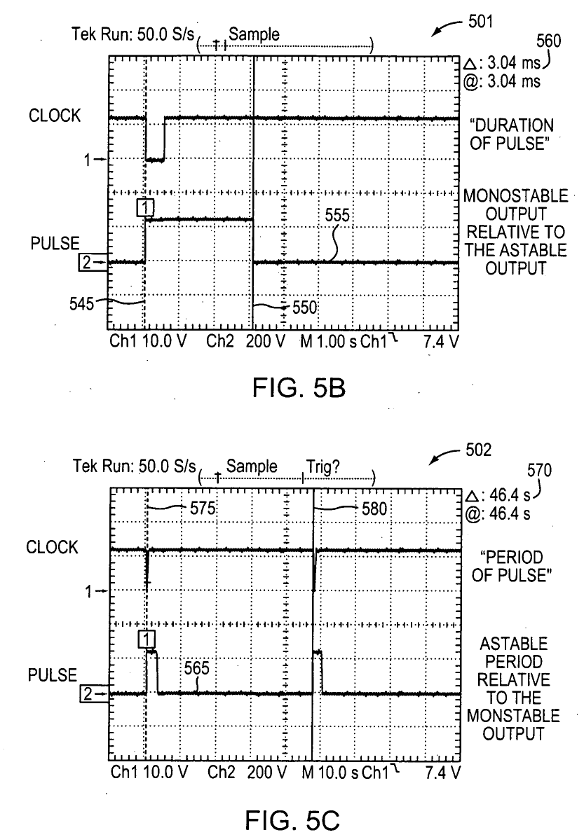

The controlled manner may also include controlling timing parameters which delineate how long, and how often current flow is enabled and disabled, as discussed below in reference to FIGS. 5A-5C. In an example embodiment, the controlled manner may include controlling the duty cycle such that, within a 45 second period, current flow is enabled for 3 seconds, and disabled for 42 seconds. A low duty cycle such as this reduces power dissipation and heat generation while still ensuring activation of a power distribution alarm monitoring circuit. Alternative duty cycles may be similarly used.

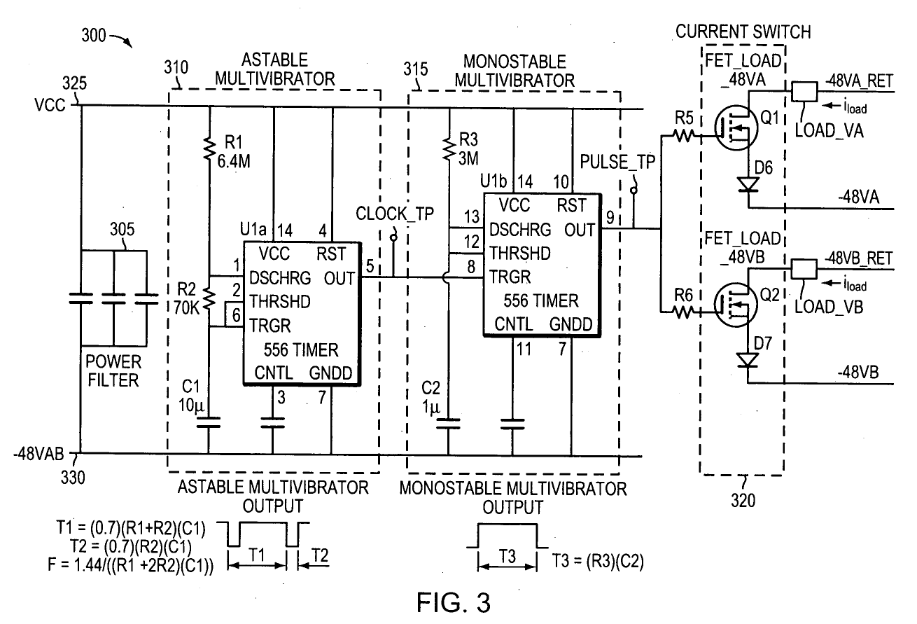

FIG. 3 is a detailed schematic diagram of pilot fuse control circuit 300 according to an example embodiment of the invention. The control circuit 300 may include an input power filter 305, timing circuit such as an astable multivibrator 310 and a monostable multivibrator 315, and output current switches 320.

Power input signals VCC 325 and −48 VAB are connected to a pilot fuse control circuit 300 and is discussed below in further detail in reference to FIG. 4. The VCC input 325 provides the high side voltage, and the −48 VAB input provides the low side voltage for the control circuit 300.

A power filter 305 is typically provided to smoothen out voltage variations and may be a parallel combination of multiple capacitors of different capacitance values targeting different frequency noise components. Of course, alternative power filter designs known in the art may be used as well.

In the example embodiment, the control circuit 300 may be configured to generate a timing signal PULSE_TP to enable loads LOAD_VA and LOAD_VB to draw current periodically for a predetermined time to ensure a pilot fuse is blown if a main line fuse is blown or missing. For example, the astable multivibrator 310 may generate a periodic clock signal CLOCK_TP, and the monostable multivibrator 315 may generate a one-shot pulse PULSE_TP to determine how long the loads draw current. The astable multivibrator may be implemented using, for example, one half of a 556 timer integrated circuit U1a. The combination of resistors R1 and R2 and capacitor C1 generates a periodic pulse that determines how often the current switches 320 are switched ‘on.’ The output signal CLOCK_TP of the astable multivibrator (U1a, pin 5) is connected to the input of the other half of the 556 timer U1b. Selecting particular values for resistor R3 and capacitor C2 can be used to program how long the current switches 320 are switched ‘on’, which, in turn, determines how long to enable the loads to draw current.

The monostable multivibrator 315 output signal (i.e., U1b, pin 9) may be connected to gate resistors R5 and R6, which are, in turn, connected to the gate of Q1 and gate of Q2, respectively. In the example embodiment, Q1 and Q2 may be implemented using an n-channel, power, metal oxide silicon field effect transistors (MOSFETs). Alternatively, the switches may be implemented using a variety of transistor types, semiconductor or mechanical switches, or other components known to those skilled in the art of electronics circuit design.

The drain of Q1 and Q2 may be connected to loads LOAD_VA and LOAD_VB, which are in turn connected to −48 VA_RET and −48 VB_RET, respectively. The source of Q1 and Q2 may be connected to diodes D6 and D7, which are in turn connected to power supply inputs −48 VA and −48 VB, respectively. In this configuration, when MOSFETs Q1 and Q2 are open or conducting, the loads are effectively connected in series between power supply leads −48 VA and −48 VA_RET and −48 VB and −48 VB_RET, respectively.

The selection of the loads' value determines how much load current is drawn through the pilot fuses. For example, with a source voltage magnitude of 48V and a load resistor of 100 ohms, the current drawn by the load equals the voltage across the load divided by the load resistance, or 48V/100Ω, or 0.48 amps. Thus, if a pilot fuse rated for 0.25 amps is used, a load drawing 0.48 amps, for a sufficient duration of time, ensures the pilot fuse is blown in the event the main line fuse is missing or blown. The example embodiment describes a power resistor load of 100Ω, however, other load values may be used. The loads may be configured as individual loads or as banks of loads. Alternatively, or in addition, other types of active or passive loads known in the art may be similarly used to ensure the desired amount of current is drawn through the pilot fuse number. It should be understood that other analog circuits, digital circuits, or combinations thereof may be used to control the current draw to blow the pilot fuse(s).

FIG. 4 is a detailed schematic diagram of a power OR'ing and conversion circuit 400 as shown in FIG. 2. The Power OR'ing and conversion circuit 400 employs a conventional diode OR'ed circuit used in conjunction with a zener diode D5, current limiting resistor R1, and Fuse F1 to generate a VCC voltage for powering the timing module 255 of FIG. 2. Much like the system it is designed to protect, the Power OR'ing and conversion circuit 400 may be powered by redundant power supplies and may be generated from the power input signals −48 VA and −48 VB. If one of the power inputs, −48 VA or −48 VB, fails or is removed from service, the other power supply is available in a redundant capacity to supply required power to the timing module 255 without interruption.

High side power inputs −48 VA and −48 VB are connected to the cathode of diodes D3 and D4, respectively. The anodes of D3 and D4 are connected together to generate a diode OR'ed voltage represented by signal −48 VAB that is further connected to the anode of the zener diode D5. The voltage rating of the zener diode D5 determines the voltage value of VCC. For example, if the zener voltage of D5 is 12V as shown in FIG. 4, VCC is equal to −48V minus 12V, or −36V. A fuse F1, connected in line with VCC, may be used to protect against over-current or other abnormal operating conditions.

The return path −48 VAB_RET is configured in a similarly manner by diode OR'ing diodes D1 and D2. The cathode of zener diode D5 is connected to resistor R1 and fuse F1. The other side of resistor R1 is, in turn, connected to the cathodes of D1 and D2. The value of resistor R1 may by selected based on the amount of current VCC is intended to provide. The anodes of D1 and D2 are independently connected to power return signals −48 VA_RET and −48 VB_RET, respectively. Alternative embodiments of the power OR'ing and conversion circuit 400 described above may be implemented using alternative components known in the art in a similar OR'ing configuration using, for example, MOSFETs, integrated circuits, and the like. Although the example embodiment describes use with negative voltages commonly used in telecommunications systems, selected components may be simply reversed for use with positive voltages.

FIGS. 5A-5C are oscilloscope screen shots capturing the output signals of the astable multivibrator 310 and the monostable multivibrator 315 as shown in FIG. 3. Signal trace CLOCK 510 represents the output of the astable multivibrator captured at testpoint CLOCK_TP, and signal trace PULSE 515 represents the output of the monostable multivibrator captured at testpoint PULSE_TP. The vertical axis 520 represents the voltage magnitude of the signal, and the horizontal axis 525 represents time.

FIG. 5A is an oscilloscope screen shot capture 500 displaying the CLOCK signal as captured at the output of the astable multivibrator relative to the monostable output. Vertical cursors 530, 535 are positioned to measure the pulse width of the CLOCK 510 signal. As displayed in the cursor delta information box 540, the pulse width is 500 milliseconds. Referring to FIG. 3, the pulse width T2 may be determined by the values of resistor R2 and capacitor C1 and may be calculated using the equation:

T2=(0.7)(R2)(C1) (eq. 1)

Thus, using the resistor and capacitor values shown in FIG. 3, equation 1 yields T2=(0.7)(70×10³)(10×10⁻⁶) or 500 milliseconds, as shown in cursor delta information box 540 of FIG. 5A.

FIG. 5B is an oscilloscope screen shot capture 501 displaying the PULSE 555 signal as captured at the output of the monostable multivibrator 315 at testpoint PULSE_TP of FIG. 3 relative to the astable multivibrator output. Vertical cursors 545 and 550 are positioned to measure the pulse width of the PULSE 555 signal. As displayed in the cursor delta information box 560, the pulse width is approximately 3 seconds. Referring to FIG. 3, the pulse width T3 may be determined by the values of resistor R3 and capacitor C3 and may be calculated using the equation:

T3=(R3)(C2) (eq. 2)

Using the resistor and capacitor values shown in FIG. 3, equation 2 yields T2=(3×10⁶)(1×10⁻⁶) or approximately 3 seconds, as shown in cursor delta information box 560 of FIG. 5B.

FIG. 5C is an oscilloscope screen shot capture 502 displaying the period of the astable multivibrator as seen on the PULSE 565 signal captured at the output of the monostable multivibrator at testpoint PULSE_TP of FIG. 3 relative to the monostable output. Vertical cursors 575 and 580 are positioned to measure the period of the PULSE 565 signal. As displayed in the cursor delta information box 570, the period is approximately 45 seconds. Referring to FIG. 3, the period T1 may be determined by the values of resistors R1 and R2 and capacitor C1 and may be calculated using the equation:

T1=(0.7)(R1+R2)(C1) (eq. 3)

Using the resistor and capacitor values shown in FIG. 3, equation 3 yields T1=(6.4×10⁶+70×10³)(10×10⁻⁶) or 3 seconds, as shown in cursor delta information box 570 of FIG. 5C.

Using the component values discussed above, an example embodiment of the present invention may be configured to enable, in a controlled manner, current flow from the power inputs to the loads such that every 45 seconds, the loads are enabled to draw 0.5 amperes of current for 3 seconds, ensuring the activation of a power distribution alarm monitoring circuit monitoring the power inputs. Thus, in a load sharing power application, a pilot fuse is blown in the event a main line fuse is blown or missing, albeit possibly as much as 45 seconds later in this example embodiment.

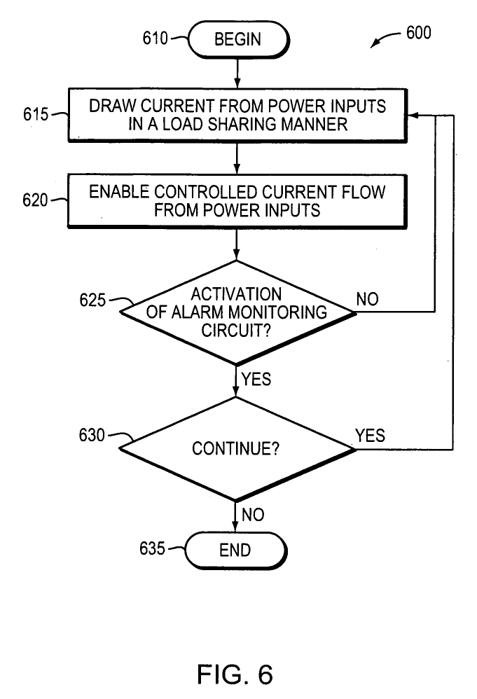

FIG. 6 illustrates, in the form of a flow diagram, an exemplary embodiment of the present invention. It should, however, be evident that various modifications and changes may be made thereto without departing from the broader spirit and scope of the present invention. For example, some of the illustrated flow diagrams may be performed in an order other than that which is described. It should be appreciated that not all of the illustrated flow diagrams is required to be performed, that additional flow diagram(s) may be added, and that some may be substituted with other flow diagram(s).

The embodiment of FIG. 6 illustrates a series of actions associated with a method for ensuring activation of a power distribution alarm monitoring circuit in a load sharing power application. The method begins (610) and draws current from power inputs in a load sharing manner (615). Current flow is enabled in a controlled manner to be drawn by the loads from the power inputs (620). If a main line fuse if blown or missing, the method ensures activation of the alarm monitoring circuit (625). If not, the method continues to draw current from power inputs in a load sharing manner (615). If the method is to continue (630), the method continues to draw current from power inputs in a load sharing manner (615). If not, the method ends (635).

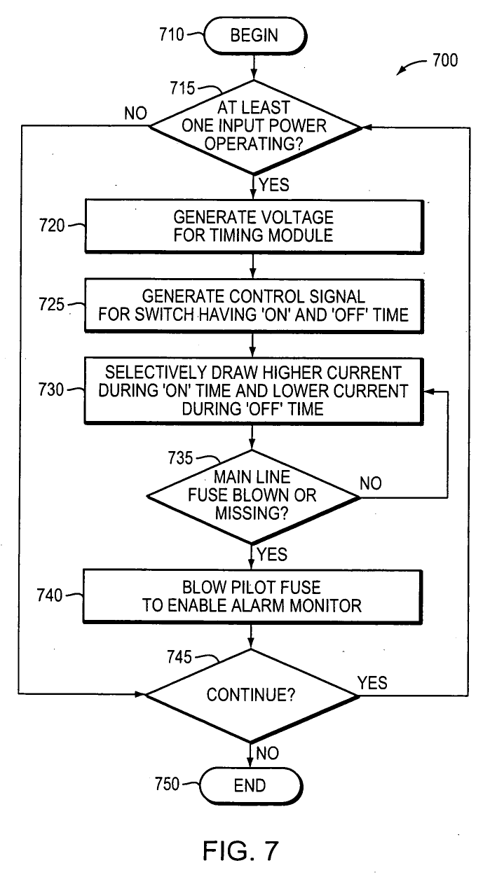

FIG. 7 is a simplified flow diagram 700, illustrating an alternative embodiment of a series of actions associated with a method for ensuring activation of a power distribution alarm monitoring circuit in a load sharing power application. The method begins (710) by determining if at least one input power supply if operating (715). At least one needs be operating since a VCC voltage for the timing module is generated from the at least on power supply input as described above in reference to FIG. 4. If at least one input power supply is not operating, the method determines whether to continue (745) waiting for an operating power supply or to end (750). If at least one input power supply is operating, the method continues by generating the VCC voltage for the timing module (720). Once the VCC voltage is stable, the timing module may generate a control signal having an ‘on’ time and an ‘off’ time (725) for the switching module. The control signal enables multiple loads to draw higher current in a selective manner during the ‘on’ time and lower current during the ‘off’ time (730). If a main line fuse is blown or missing, the higher current may blow the pilot fuse to enable an alarm monitoring circuit (740). If continuing (745), at least one input power supply continues to be operating (715). If not, the method ends (750).

While this invention has been particularly shown and described with references to example embodiments thereof, it will be understood by those skilled in the art that various changes in form and details may be made therein without departing from the scope of the invention encompassed by the appended claims.

What is claimed is:

1. An apparatus for ensuring activation of a power distribution alarm monitoring circuit in a load sharing power application, comprising:
multiple loads configured to draw current from power inputs in a load sharing manner; and
a control circuit configured to enable, in a controlled manner, current flow from the power inputs to the loads at levels to ensure activation of a power distribution alarm monitoring circuit monitoring the power inputs.

2. The apparatus according to claim 1, further including switching devices coupled to respective loads, wherein the control circuit is configured to provide a control signal to the switching devices to enable, in a controlled manner, the current flow from the power inputs to the loads via the switching devices.

3. The apparatus according to claim 1, wherein the control circuit in combination with the load is configured to cause an increase in current flow to the load for a length of time above a level to ensure activation of the power distribution alarm.

4. The apparatus according to claim 3, wherein the level is between 0.25 amperes and 10 amperes.

5. The apparatus according to claim 1, wherein the control circuit is configured to enable current flow in a timed manner.

6. The apparatus according to claim 5, wherein the timed manner is one of the following: periodic, aperiodic, or selectable.

7. The apparatus according to claim 1, wherein the control circuit comprises at least one multivibrator.

8. The apparatus according to claim 7, wherein the control circuit comprises an astable multivibrator and a monostable multivibrator.

9. The apparatus according to claim 1, wherein the control circuit is configured to cause the current flow to have at least two states with one state higher current flow than the other state.

10. The apparatus according to claim 9, wherein the control circuit is configured to cause the current flow to have an ‘on’ time and an ‘off’ time and wherein the current flow ‘on’ time is substantially less than the current flow ‘off’ time.

11. The apparatus according to claim 1, wherein the apparatus is configured for use in a telecommunications application.

12. The apparatus according to claim 1, further including a circuit to derive an operational voltage to power the control circuit from at least one of the power inputs.

13. The apparatus according to claim 12, wherein the apparatus continues to operate in an event of a loss of a power input.

14. The apparatus according to claim 12, wherein the operational voltage is floating relative to ground.

15. The apparatus according to claim 1, wherein the loads are at least one of the following types of loads: active, passive, or a short to reference voltage potential.

16. The apparatus according to claim 1, wherein the loads are in equal number as the power inputs.

17. The apparatus according to claim 1, wherein the loads are configured in banks of loads and the banks are coupled to respective power inputs.

18. A method for ensuring activation of a power distribution alarm monitoring circuit in a load sharing power application, the method comprising:
drawing current from power inputs in a load sharing manner; and
enabling, in a controlled manner, current flow from the power inputs at levels to ensure activation of a power distribution alarm monitoring circuit monitoring the power inputs.

19. The method according to claim 18, wherein enabling the current flow in a controlled manner includes selectively drawing the current from the power inputs at levels to ensure activation of the power distribution alarm monitoring circuit.

20. The method according to claim 18, further including increasing current flow from the power inputs for a length of time above a level to ensure activation of the power distribution alarm monitoring circuit.

21. The method according to claim 20, wherein the level is between 0.1 amperes and 10 amperes.

22. The method according to claim 18, wherein enabling the current flow includes enabling the current flow to flow from the power inputs in a timed manner.

23. The method according to claim 22, wherein enabling current flow in the timed manner is selected from a group consisting of: periodic, aperiodic, or selectable.

24. The method according to claim 18, wherein generating the control signal includes generating a multivibrating control signal.

25. The method according to claim 24, wherein generating the control signal includes generating an astable multivibrating control signal in combination with a monostable multivibrating control signal and wherein enabling the current flow occurs during an ‘on’ state of the monostable multivibrating control signal.

26. The method according to claim 18, wherein enabling the current flow includes causing the current flow to flow in at least two states with one state having a higher current flow than at least one other state.

27. The method according to claim 26, wherein enabling the current flow includes causing the current flow to have an ‘on’ time and an ‘off’ time and wherein the ‘on’ time is substantially less than the ‘off’ time.

28. The method according to claim 18, further including using the method in a telecommunications application.

29. The method according to claim 18, further including deriving an operational voltage to power the control circuit from at least one of the power inputs.

30. The method according to claim 29, further including continuing to operate in an event of a loss of power at a power input.

31. The method according to claim 29, wherein the operational voltage is floating relative to ground.

32. The method according to claim 18, wherein drawing the current includes drawing the current in at least one of the following manners: actively, passively, or via a short to a reference voltage potential.

33. The method according to claim 18, wherein drawing the current includes drawing the current via loads in equal number as the power inputs.

34. The method according to claim 18, wherein drawing the current includes drawing the current via banks of loads coupled to respective power inputs.

35. An apparatus for ensuring activation of a power distribution alarm monitoring circuit in a load sharing power application, comprising:
means for drawing current from power inputs in a load sharing manner; and
means for enabling, in a controlled manner, current flow from the power inputs at levels to ensure activation of a power distribution alarm monitoring circuit monitoring the power inputs.
